(19) United States
(12) Patent Application Publication
(10) Pub. No.: US 2007/0234610 A1
(43) Pub. Date: Oct. 11, 2007

(54) Digital display bin

(76) Inventors: Jasen M. Pelak, Oak Ridge, NJ (US); Lisa Y. Urso, Edgewater, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/401,128

(22) Filed: Apr. 10, 2006

(51) Int. Cl. G06F 3/038; G09G 5/00; G09F 23/00

(52) U.S. Cl. 40/567

(57) ABSTRACT

A digital display bin for displaying advertising content and for receiving and storing trash is disclosed, comprising a base attached to four vertical walls, three of the vertical walls including a digital display screen; and a fourth vertical wall hingedly connected to the digital display bin. Further disclosed is a top portion connected to the vertical walls having at least one aperture for receiving trash; and trash means for receiving and temporarily storing the trash, the trash means being removably located within the interior space of the digital display bin. The digital display bin includes at least three casters located on the underside of the base for allowing movement of the bin. The digital display bin includes computer means for storing a plurality of advertising clips having video content and for controlling the playback of the advertising clips; power supply means for providing power to the display screens and the computer means, respectively. In one aspect of the invention, the display screens are mounted on a tri-wall located in the interior space of the digital display bin. Preferably, a plurality of fans is located on the fourth vertical wall for providing a continuous airflow around the digital display screens for maintaining an appropriate operating temperature.

### BACKGROUND OF THE INVENTION

1. Field of the Invention

The present invention relates to a digital display bin; and more particularly, to a bin that houses a plurality of digital display screens for displaying advertising content, and is additionally operable for receiving and storing trash.

2. Description of the Prior Art

Trash bins are prevalent in most public areas, such as city sidewalks, train stations, bus stations, airports, malls, sporting arenas, locker rooms, bathrooms, building lobbies, movie theatres, and the like. Trash bins, or receptacles, are necessary for providing a location for people to deposit certain items of trash as part of everyday life. Such trash items include articles of refuse, such as empty soda bottles and cans, food wrappers, newspapers, magazines, and the like. Because of their nature and general appearance, common trash bins found in the prior art are unattractive and unpleasant to view while in a public place. Attempts at making the trash bins more attractive have involved integrating advertising signage to the outside panels of the trash bin, therefore having a dual purpose—advertisement and trash collection. Such examples can be found at U.S. Pat. No. 1,424,519 to Richardson; U.S. Pat. No. 2,543,008 to French; U.S. Pat. No. 3,793,756 to Kay et al.; U.S. Pat. No. 3,803,738 to Weiss; U.S. Pat. No. 3,947,985 to Skrzypczak; U.S. Pat. No. 4,827,645 to Stamps, Jr.; U.S. Pat. No. 5,014,985 to Capps; U.S. Pat. No. 5,624,018 to Schuff et al.; U.S. Pat. No. 5,947,584 to Passanante et al.; U.S. Pat. No. 6,012,790 to Thomas et al.; U.S. Pat. No. 6,691,897 to Ashe; and US Patent Application Publication No. 2004/0178198. None of these teachings disclose or suggest the use of digital display screens, such as plasma, LCD, or DLP screens.

Other prior art attempts have disclosed the use of digital display screens. For example, U.S. Pat. No. 6,802,143 to Rachowitz et al. discloses a reliable, rotating, illuminated advertising unit that utilizes independent display modules housing lights and advertising material. Optionally, Rachowitz discloses that AMLCD, plasma, or similar flat-panel displays may be used in the display modules. The display modules in Rachowitz surround a hollow central compartment that may be used as a trash container. Significantly, Rachowitz does not include ventilation means for the digital display screens. Further, the Rachowitz device has curved sidewalls and a circular base.

PCT Application Publication No. WO 00/55833 to Angel discloses a combined advertising display and trash receptacle business system. Angel discloses that the side panels may include an electrically powered, flat screen monitor of, for example, the LCD (liquid crystal display) type, etc. Significantly, Angel does not disclose or suggest ventilation means for the digital display screens. Further, the Angel device does not include casters at its base for movement of the unit.

PCT Application Publication No. WO 03/050790 to Passannante discloses an illuminated advertising trash receptacle. Passannante discloses that the side panels may include display screen implemented as LCD, LED, plasma screens, or any other appropriate illumination screens for displaying electronic advertisements and may even be an array of LED lights for displaying a moving message. Significantly, the Passannante device does not disclose or suggest ventilation means for the digital display screens.

There remains a need in the art for an attractive, functional, digital display bin having an integrated trash receptacle that provides means for displaying advertising content to the public via digital display screens such as plasma, LCD, DLP, and the like, wherein the digital display bin further includes ventilation means for the digital display screens.

### SUMMARY OF THE INVENTION

The present invention provides an attractive, functional digital display bin for displaying advertising content and for receiving and storing trash. Advertising content is displayed to the public via digital display screens, such as plasma, LCD, DPL, and the like. A ventilation means housed within the bin protects digital components from exceeding critical temperatures by facilitating release of accumulated heat.

Generally stated, the digital display bin comprises: (i) a base having a first side, a second side, a third side, a fourth side, an underside, and a topside, respectively; (ii) a first vertical wall connected to said first side of said base, said first vertical wall housing a first display screen selected from the group consisting of plasma screens, liquid crystal display screens, and DLP screens; (iii) a second vertical wall connected to said second side of said base, said second vertical wall housing a second display screen selected from the group consisting of plasma screens, liquid crystal display screens, and DLP screens; (iv) a third vertical wall connected to said third side of said base, said third vertical wall housing a third display screen selected from the group consisting of plasma screens, liquid crystal display screens, and DLP screens; (v) a fourth vertical wall hingedly connected to said third vertical wall, said fourth vertical wall being positioned between said first vertical wall and said third vertical wall, respectively; (vi) a top portion connected to said vertical walls, said top portion having at least one aperture for receiving trash; (vii) said vertical walls, base, and top portion, collectively, defining an interior space; (viii) trash means for receiving and temporarily storing said trash, said trash means being removably located within said interior space; (ix) at least three casters located on the underside of said base for allowing movement of said bin; (x) computer means for storing a plurality of advertising clips having video content and for controlling the playback of said advertising clips; (xi) power supply means for providing power to said display screens and said computer means, respectively; and (xii) ventilation means for cooling the first, second, and third display screens, respectively, wherein the ventilation means comprises a plurality of fans.

In one aspect of the invention, the display screens are mounted on a tri-wall located in the interior space of the digital display bin. A plurality of fans is located on the fourth vertical wall for providing a continuous air flow around the digital display screens and through a cavity formed by the tri-wall for maintaining an appropriate operating temperature.

The present invention solves the problems associated with public trash receptacles and their generally unsightly appearance. In accordance with the present invention, advertising units displaying video content on digital display screens are integrally associated with public trash receptacles to provide an aesthetically pleasing unit that allows for increased exposure of video advertising in public places. The digital display bin benefits the general public and the advertisers who utilize the video advertising service displayed via the digital display screens associated therewith.

### BRIEF DESCRIPTION OF DRAWINGS

The invention will be more fully understood and further advantages will become apparent when reference is had to the following detailed description of the preferred embodiments and the accompanying drawings, in which:

FIG. 1 is a perspective view depicting the front of the digital display bin in accordance with the invention;

FIG. 2 is a perspective view depicting the back of the digital display bin in accordance with the invention;

FIG. 3 is a top view depicting the interior portion of the digital display bin in accordance with the invention; and

FIG. 4 is a perspective view depicting the back of the digital display bin and associated ventilation means in accordance with the invention.

### DESCRIPTION OF THE PREFERRED EMBODIMENTS

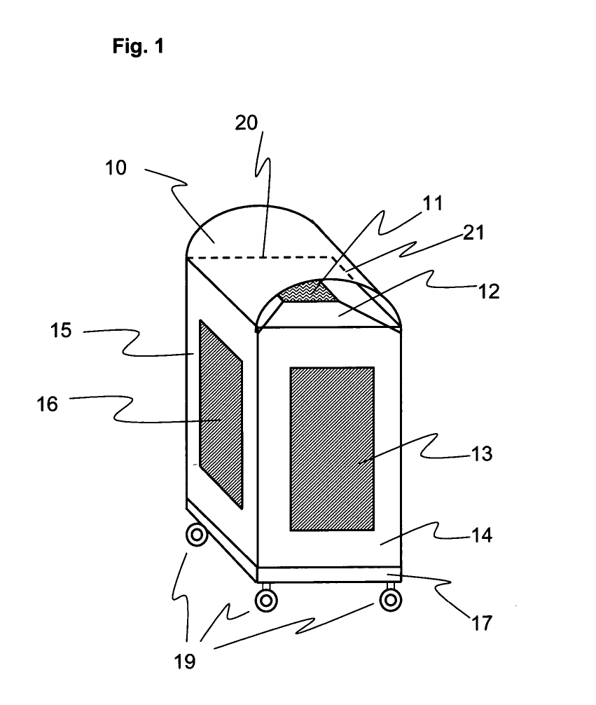

The digital display bin of the present invention is operable for placement in a wide variety of public places, such that persons who are in relative proximity to the digital display bin may view its display screens. The digital display bin further comprises means for receiving and temporarily storing trash. Advertisers can reach thousands of potential consumers by having their advertising content displayed on the display screens associated with the digital display bin. The digital display bin is generally depicted at FIGS. 1-4.

The digital display bin is shown generally at FIG. 1, from the front view. The digital display bin includes a plurality of display screens 13, 16 for displaying advertising video content. The display screens 13, 16 are selected from the group consisting of: plasma screens, liquid crystal display screens, DLP screens, and the like. Preferably, the display screens are protected from the environment by an exterior metal frame including a layer of Lexan (Plexiglas™), or the like (not shown). Preferably, the digital display bin has four vertical walls 14, 15, 20, 21, wherein three of the walls 14, 15, 21 house display screens 13, 16, and 22 (not shown), respectively. Preferably each vertical wall has a separate metal frame and layer of Plexiglas™ (not shown) that is bolted to the outside of it and covers and protects the digital display screen. When access to a display screen is necessary, the metal frame is un-bolted and removed. In this embodiment, the fourth wall 20 does not include a display screen, but instead is hingedly connected to the third wall 15 to provide access to the interior space of the digital display bin. Trash means (not shown) is located within the interior space of the digital display bin for receiving and temporarily storing trash. The digital display bin comprises a base 17; and a top portion 12 having an aperture 11 for receiving trash. Preferably, the top portion of the digital display bin further comprises a funnel design 12 to ensure that the trash is properly routed to the internal trash receptacle. Preferably, the top portion of the digital display bin further includes a semi-circular dome top 10 for covering the aperture 11 and for enhancing the aesthetic appeal.

Preferably, the digital display bin further comprises at least three, and preferably four, heavy-duty casters 19 (fourth not shown) located on the underside of its base 17 for allowing movement of the bin. The digital display bin further comprises computer means (not shown) for storing a plurality of digital advertising clips having video content and for controlling the playback of the digital advertising clips. The digital display bin includes power supply means (not shown) for providing power to the display screens and the computer. In an alternative embodiment, the digital display bin further comprises at least one speaker (not shown) for broadcasting audio content that may be associated with the digital advertising clips.

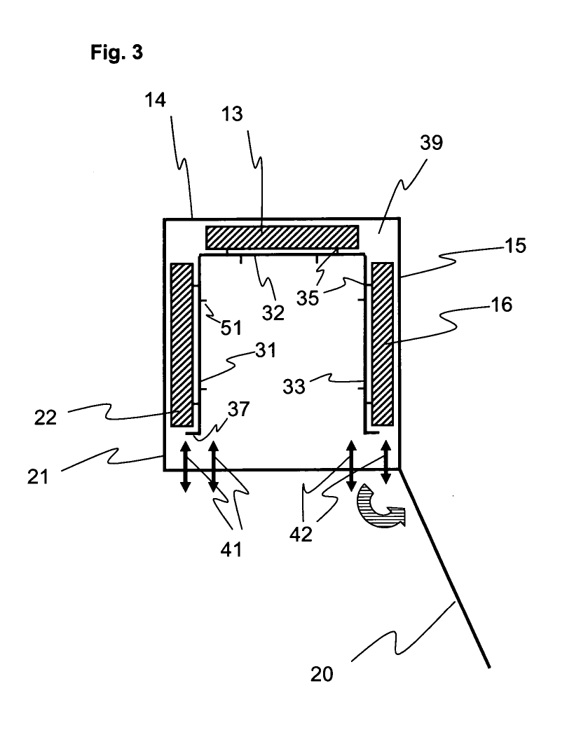

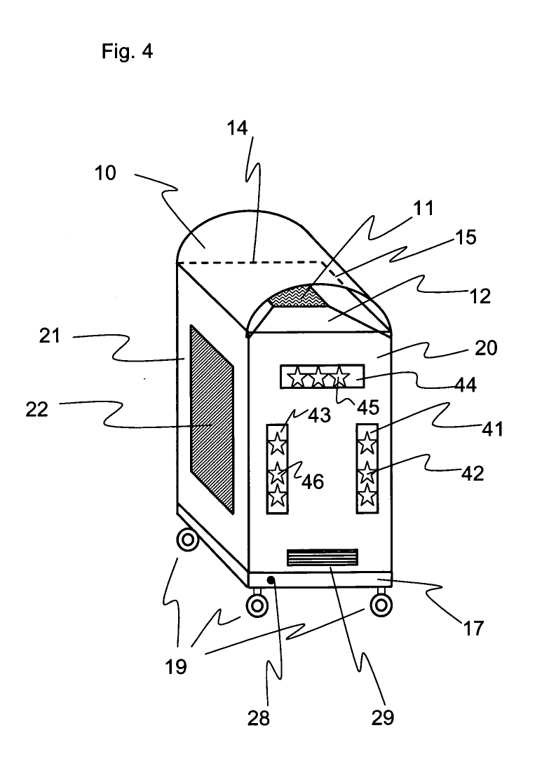

In the preferred embodiment, the digital display bin of the present invention comprises: (i) a base 17 having a first side, a second side, a third side, a fourth side, an underside, and a topside, respectively; (ii) a first vertical wall 21 connected to said first side of said base, said first vertical wall housing a first display screen 22 (not shown) selected from the group consisting of plasma screens, liquid crystal display screens, and DLP screens; (iii) a second vertical wall 14 connected to said second side of said base, said second vertical wall housing a second display screen 13 selected from the group consisting of plasma screens, liquid crystal display screens, and DLP screens; (iv) a third vertical wall 15 connected to said third side of said base, said third vertical wall housing a third display screen 16 selected from the group consisting of plasma screens, liquid crystal display screens, and DLP screens; (v) a fourth vertical wall 20 hingedly connected to said third vertical wall 15, said fourth vertical wall being positioned between said first vertical wall 21 and said third vertical wall 15, respectively; (vi) a top portion 12 connected to said vertical walls, said top portion having at least one aperture 11 for receiving trash; (vii) said vertical walls, base, and top portion, collectively, defining an interior space; (viii) trash means (not shown) for receiving and temporarily storing said trash, said trash means being removably located within said interior space; (ix) at least three casters 19 located on the underside of said base 17 for allowing movement of said bin; (x) computer means (not shown) for storing a plurality of advertising clips having video content and for controlling the playback of said advertising clips; (xi) power supply means (not shown) for providing power to said display screens and said computer means, respectively; and (xii) ventilation means (see FIGS. 3-4) for cooling the first, second, and third display screens, respectively, wherein the ventilation means comprises a plurality of fans (FIG. 4). Preferably, the digital display bin has four casters, one at each corner of the underside of the base, for allowing movement of the bin. The bin is manufactured of an all-aluminum construction in order to provide a lightweight and durable apparatus. The base is square and each of the digital display screens is approximately the same size. An aperture 11 for receiving trash is associated with a funnel design to assist in depositing of trash into the trash means of the digital display bin. The type of digital display screen may be selected from the group consisting of plasma screens, liquid crystal display screens, and DLP screens; as well as other similar types of digital display screens now known or hereafter developed.

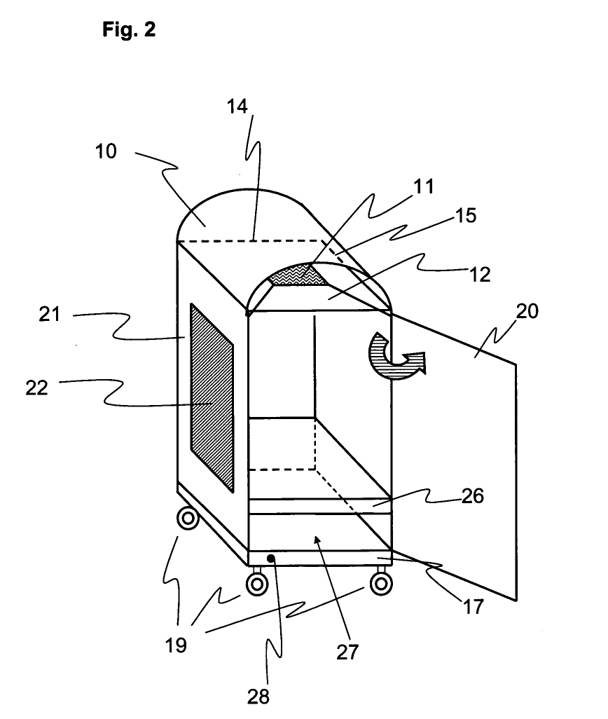

FIG. 2 depicts the rear view of the digital display bin of the present invention. FIG. 2 shows the digital display bin depicted in FIG. 1, but rotated by 180 degrees. The fourth vertical wall 20 is shown in the open configuration being hingedly connected to the third vertical wall 15 and swinging open as shown by the shaded arrow. Once the fourth vertical wall 20 is opened, the inside of the digital display bin is accessible. Preferably a security mechanism, such as a padlock or combination lock is associated with the digital display bin for preventing unauthorized access to the inside of the digital display bin. Such a security mechanism is located at the intersection of the fourth vertical wall 20 and the second vertical wall 21.

A shelf 26 is preferably located near the base 17 of the digital display bin. The shelf 26 may be part of a freestanding unit that is removable from the digital display bin; in other words, the shelf 26 may not be fixedly attached to the digital display bin. The shelf 26 provides a flat surface to rest a removable trash means (not shown) for receiving and storing trash. Preferably the trash means consists of a 50 gallon garbage can, composed of durable plastic. The trash means is removed from the digital display bin periodically to empty the trash from the trash means. To remove the trash means, the fourth vertical wall 20 is opened and the trash means is slid along the shelf surface. The trash means fits tightly in the digital display bin and fully utilizes substantially all of the interior space. Shelf 26 further provides an interior cavity at 27 below the trash means for storing the computer means (not shown) for storing a plurality of advertising clips having video content and for controlling the playback of said advertising clips; and for storing the power supply means (not shown) for providing power to the display screens and the computer means, respectively. Power is provided to the electronic equipment via a standard 115 voltage AC outlet, wherein the power cord is routed through a small aperture 28 in the base 17 of the digital display unit. Preferably, the fourth vertical wall 20 does not house a digital display screen, but rather includes a plurality of fans and vents (see FIG. 4) to provide ventilation to the electronic equipment associated with the digital display bin. The digital display bin can be pushed up near a wall (not shown) so that the fourth vertical wall 20 is next to that wall. Typically, said wall (not shown)is provided with a power outlet into which the power wire for the digital display bin is inserted.

The power supply of the digital display bin comprises an electrical wire, operable for connection with a standard wall socket. Alternatively, the power supply of the digital display bin comprises an internal battery source. Preferably, the computer means is simple to use, reliable, lightweight, and compact, and is of the type readily known to those in the relevant art. One example of a suitable computer means is sold under the name Alivepromo AP350 Content Player PC™. The computer means may be wireless used with wi-fi or Verizon Wireless™. Preferably, the computer means is housed within protected cabinetry mounted near the base of the digital display bin at cavity 27. Preferably a second security means prevents unauthorized access to the cavity 27 housing the computer and power means, respectively.

The digital display bin comprises ventilation means for cooling the display screens and preventing them from overheating. As shown in a top view of the digital display bin at FIG. 3, in a preferred embodiment, each of the three display screens 22, 13, 16 is mounted on each side of an interior tri-wall, 31, 32, and 33, respectively. The back of each of the digital display screens is mounted to the tri-wall; spacers 35 allow for a space between the back of the digital display screen and the tri-wall to provide for improved ventilation and air flow. Preferably, the distance from the back of the digital display screen to the tri-wall is in the range of 0.25 to 1.5 inches, and preferably about 0.5 inches, as provided by the spacers 35. The tri-wall design allows for a continuous internal cavity 39 for placement of the display screens, wherein air can continuously flow around the display screens, as shown generally by the arrows at 41 and 42, respectively. The digital display screens are positioned in the internal cavity 39, defined by the tri-wall on one side and the vertical wall of the display bin on the other side. A plurality of fans, preferably nine (9), is mounted on the fourth vertical wall (FIG. 4) for generating the air flow within the tri-wall, thereby creating a continuous cooling effect for the display screens. The interior tri-wall allows a continuous air flow around the digital display screens for a cooling effect wherein the tri-wall forms an interior cavity that continuously flows along the first, second, and third vertical wall, respectively. A trash means (not shown), preferably a plastic garbage liner, is positioned within the tri-wall and preferably is appropriately sized so that a small gap exists between the trash means and the tri-wall. Preferably, spacers 51 operate to maintain said small gap between the trash means and the tri-wall. Preferably the tri-wall extends the full height of the interior space above the shelf 26. Preferably the free ends of the tri-wall have a lip at a right-angle, as seen from a top view and shown at 37, to provide further structural support to the tri-wall as it supports the digital displays associated with the present invention. Preferably, the lip 37 is cut out in order to line up with the corresponding fan plates 41 and 43 (see FIG. 4); therefore the lip 37 prevents air from flowing out of the cavity 39 defined by the tri-wall and, instead, air flows out through a plurality of vents (not shown) located in the tri-wall itself. Therefore, each of the walls 31, 32, and 33 of the tri-wall has a plurality of vents for further enhancing the ventilation means of the invention.

FIG. 4 shows one aspect of the ventilation means associated with the fourth vertical wall. Built into the fourth vertical wall 20 are three fan plates. A first fan plate 43 is located at the lower left location of the fourth vertical wall 20 and includes at least one, and preferably three, fans at 46. A second fan plate 41 is located at the lower right location of the fourth vertical wall 20 and includes at least one, and preferably three, fans at 42. Preferably, the fans 46 and 42 blow air into the interior space of the digital display bin. Preferably the first wall 31 of the tri-wall is located near the midpoint of the first fan plate 43 such that air is blown on both sides of the tri-wall—that is the first side being the cavity 39 and the second side being the gap between the tri-wall and the trash means. Similarly, the third wall 33 of the tri-wall is located near the midpoint of the second fan plate 41 such that air is blown on both sides of the tri-wall. In this embodiment air is circulated around the digital display screens and also around the trash means for maximum cooling capabilities of the digital display bin. A third fan plate 44 is located at the top location of the fourth vertical wall 20 and includes at least one, and preferably three, fans at 45. Preferably, the fans 45 blow air out of the interior space, thereby expelling any hot air that has accumulated within the interior space of the digital display bin. The third fan plate 45 is located at the top location of the fourth vertical wall because of the fact that hot air rises. Preferably, a vent plate 29 is located along the bottom portion of the fourth vertical wall 20 to provide ventilation to the electronic equipment below the shelf 26 in cavity 27 (see FIG. 2). In another embodiment, a thermostat (not shown) is located within the interior portion of the digital display bin for triggering the ventilation means when the temperature exceeds a pre-selected critical point. In still another embodiment, an on/off timer (not shown) is located within the interior portion of the digital display bin and controls the operation of the ventilation means and/or the digital display screens.

The ventilation means of the present invention is a significant aspect of the present invention in order to ensure that the digital display screens do not overheat. In order for the digital display screens to function properly, their operating temperatures, respectively, must remain below a critical temperature. Said critical temperature varies based on the type and brand of digital display screen and is readily known to those skilled in the art. Certain digital display screens have a critical temperature of approximately 100 degrees Fahrenheit. The tri-wall design and plurality of fans of the present invention allows continuous air circulation within the bin and around the display screens and permits the continuous and reliable functionality of the digital display screens associated with the present digital display bin. A further advantage of the ventilation means disclosed by the present invention is that it slows down the decay and formation of bacteria in any food-related trash item that may temporarily reside within the trash means of the present invention. Said decay and bacteria formation are undesirable and result in foul smelling trash.

The digital display bin is suitable for placement at many public areas, including, for example, subway, bus, and train stations, airports, malls, theaters, sports arenas, office buildings, and the like. The digital display bin adds décor to any indoor venue. The digital display bin provides a media stream for advertisers, with potential to reach large audiences which have previously remained largely untapped. The digital display bin combines the traditional waste receptacle with cutting-edge digital signage. The three-dimensional design of the digital display bin enables high frequency potential giving it the ability to be seen from any direction. This feature is highly beneficial, as it results in a favorable impression for advertisers.

It should be understood that the number of digital display screens associated with the digital display bin may vary. For example, the fourth vertical wall 20 may include a digital display screen similar to the other three vertical walls, resulting in a total of four digital display screens. In such an embodiment, the plurality of fans is preferably located below the digital display screen on the fourth vertical wall 20. Further, the digital display bin may include only one digital display screen, or two digital display screens. Alternatively, each vertical wall of the digital display bin may include more than one digital display screen.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A digital display bin for displaying advertising content and for receiving and storing trash, comprising:
a. a base having a first side, a second side, a third side, a fourth side, an underside, and a topside, respectively;
b. a first vertical wall connected to said first side of said base, said first vertical wall housing a first display screen selected from the group consisting of plasma screens, liquid crystal display screens, and DLP screens;
c. a second vertical wall connected to said second side of said base, said second vertical wall housing a second display screen selected from the group consisting of plasma screens, liquid crystal display screens, and DLP screens;
d. a third vertical wall connected to said third side of said base, said third vertical wall housing a third display screen selected from the group consisting of plasma screens, liquid crystal display screens, and DLP screens;
e. a fourth vertical wall hingedly connected to said third vertical wall, said fourth vertical wall being positioned between said first vertical wall and said third vertical wall, respectively;
f. a top portion connected to said vertical walls, said top portion having at least one aperture for receiving trash;
g. said vertical walls, base, and top portion, collectively, defining an interior space;
h. trash means for receiving and temporarily storing said trash, said trash means being removably located within said interior space;
i. at least three casters located on the underside of said base for allowing movement of said bin;
j. computer means for storing a plurality of advertising clips having video content and for controlling the playback of said advertising clips;
k. power supply means for providing power to said display screens and said computer means, respectively; and
l. ventilation means comprising a plurality of fans for cooling the first, second, and third display screens.

2. The digital display bin as recited by claim 1 having four casters located on the underside of said base for allowing movement of said bin.

3. The digital display bin as recited by claim 1 further comprising a security means for preventing unauthorized access to the interior space and preventing opening of the fourth vertical wall.

4. The digital display bin as recited by claim 1 wherein the construction is all-aluminum.

5. The digital display bin as recited by claim 1 wherein the base further comprises an aperture for routing a power cord for the power supply means.

6. The digital display bin as recited by claim 1 further comprising a semi-circular dome top located over the top portion for preventing easy access to the trash means.

7. The digital display bin as recited by claim 1 wherein the ventilation means further comprises an interior tri-wall for allowing a continuous air flow around the digital display screens for a cooling effect wherein the tri-wall forms an interior cavity that continuously flows along the first, second, and third vertical wall, respectively.

8. The digital display bin as recited by claim 7 wherein the digital display screens are mounted to each side of the tri-wall, respectively, and are located with the interior cavity formed by the tri-wall.

9. The digital display bin as recited by claim 7 wherein the tri-wall includes a plurality of vents.

10. The digital display bin as recited by claim 1 wherein the fourth vertical wall further comprises a plurality of vents.

11. The digital display bin as recited by claim 1 wherein said plurality of fans are mounted on the fourth vertical wall.

12. The digital display bin as recited by claim 11 wherein at least one fan blows air into the interior space of the digital display bin and at least one fan blows air out of the interior space of the digital display bin.

13. The digital display bin as recited by claim 12 wherein the at least one fan blowing air out of the digital display bin is located near the top portion of said fourth vertical wall.

14. The digital display bin as recited by claim 1 wherein the base is square.

15. The digital display bin as recited by claim 1 wherein each of the digital display screens is about the same size.

16. The digital display bin as recited by claim 1 wherein said aperture for receiving trash includes a funnel design to assist in depositing trash into the digital display bin.

17. The digital display bin as recited by claim 1 wherein the digital display bin further comprises a thermostat for controlling the operation of the plurality of fans.

18. The digital display bin as recited by claim 1 wherein the digital display bin further comprises an on/off timer for controlling the operation of the ventilation means.

19. The digital display bin as recited by claim 1 further comprising a shelf defining a cavity in the interior portion of the digital display bin for housing said computer means and said power supply means, and wherein said trash means rests on said shelf.

20. The digital display bin as recited by claim 1 wherein said trash means comprises a plastic liner.

21. The digital display bin as recited by claim 1 wherein a fourth digital display screen selected from the group consisting of plasma screens, liquid crystal display screens, and DLP screens, is housed on the fourth vertical wall.
